(19) United States
(12) Patent Application Publication
(10) Pub. No.: US 2008/0162857 A1
(43) Pub. Date: Jul. 3, 2008

(54) MEMORY DEVICE WITH MULTIPLE CONFIGURATIONS

(76) Inventor: Jong Hoon Oh, Chapel Hill, NC (US)

Correspondence Address: PATTERSON & SHERIDAN, LLP;Gero McClellan / Qimonda, 3040 POST OAK BLVD.,, SUITE 1500, HOUSTON, TX, 77056, US

(21) Appl. No.: 11/618,546

(22) Filed: Dec. 29, 2006

(51) Int. Cl. G06F 12/00; G06F 13/00

(52) U.S. Cl. 711/170; 710/35; 711/E12.084

(57) ABSTRACT

A memory device and a method of providing the memory device. The method includes providing the memory device with a memory array arrangement of width N and providing a first configuration of the memory device and a second configuration of the memory device. Providing the first configuration of the memory device includes providing the memory device with a data pin output of width N/M and a burst length of M, where M is less than N. Providing the second configuration of the memory device comprises providing a data pin output of width N/P and a burst length of P, where P is less than M, wherein M, N, and P are all integers.

### BACKGROUND OF THE INVENTION

Modern computer systems typically contain a high-speed volatile memory device such as a dynamic, random access memory (DRAM) device which may be used to store data for the computer system. A memory device typically includes an interface with command pins, address pins, and data pins via which data in the memory device may be accessed. The speed with which data can be transmitted to or from the memory device may be referred to as the bandwidth of the memory device.

In many cases, different types of computer systems may be configured to access different types of memory devices. Such requirements may depend on the manufacturer using the memory device or on the type of computer system in which the memory device is to be used. For example, one manufacturer may desire a memory device which provides an interface with a low data pin count while another manufacturer may tolerate memory device with an interface which provides a higher data pin count.

Where the memory device provides an interface with a low data pin count, the amount of data which may be transferred to or from the memory device during a given access, and thus the bandwidth, may be reduced correspondingly. However, for both the high data pin count and the low data pin count, each manufacturer may desire a memory device with the largest possible bandwidth. Also, with respect to a manufacturer of the memory device, the memory device manufacturer may want to provide each type of device (e.g., low pin count and high pin count) to its customers while minimizing design, testing, and manufacturing costs.

Accordingly, what is needed are improved methods and apparatuses for providing configurations of a memory device.

### SUMMARY OF THE INVENTION

Embodiments of the invention provide a memory device and a method of providing the memory device. In one embodiment, the method includes providing the memory device with a memory array arrangement of width N and providing a first configuration of the memory device and a second configuration of the memory device. Providing the first configuration of the memory device includes providing the memory device with a data pin output of width N/M and a burst length of M, where M is less than N. Providing the second configuration of the memory device comprises providing a data pin output of width N/P and a burst length of P, where P is less than M, wherein M, N, and P are all integers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting a memory device according to one embodiment of the invention.

FIG. 2 is a flow diagram depicting a process for providing configurations of a memory device according to one embodiment of the invention.

FIG. 3 is a block diagram depicting one configuration of a memory device according to one embodiment of the invention.

FIG. 4 is a timing diagram depicting a read operation performed on the memory device of FIG. 3 according to one embodiment of the invention.

FIG. 5 is a timing diagram depicting a write operation performed on the memory device of FIG. 3 according to one embodiment of the invention.

FIG. 6 is a block diagram depicting another configuration of a memory device according to one embodiment of the invention.

FIG. 7 is a timing diagram depicting a read operation performed on the memory device of FIG. 6 according to one embodiment of the invention.

FIG. 8 is a timing diagram depicting a write operation performed on the memory device of FIG. 6 according to one embodiment of the invention.

FIG. 9 is a timing diagram depicting alternate timing of a write operation performed on the memory device of FIG. 6 according to one embodiment of the invention.

### DETAILED DESCRIPTION OF THE PREFERRED EMBODIMENT

Embodiments of the invention provide a memory device and a method of providing memory device. In one embodiment, the method includes providing the memory device with a memory array arrangement of width N and providing a first configuration of the memory device and a second configuration of the memory device. Providing the first configuration of the memory device includes providing the memory device with a data pin output of width N/M and a burst length of M, where M is less than N. Providing the second configuration of the memory device comprises providing a data pin output of width N/P and a burst length of P, where P is less than M, wherein M, N, and P are all integers.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Also, signal names used below are exemplary names, indicative of signals used to perform various functions in a given memory device. In some cases, the relative signals may vary from device to device. Furthermore, the circuits and devices described below and depicted in the figures are merely exemplary of embodiments of the invention. As recognized by those of ordinary skill in the art, embodiments of the invention may be utilized with any memory device, including, for example, a double-data rate synchronous dynamic random access memory (DDR-SDRAM) device such as a low power (LP) DDR-SDRAM device.

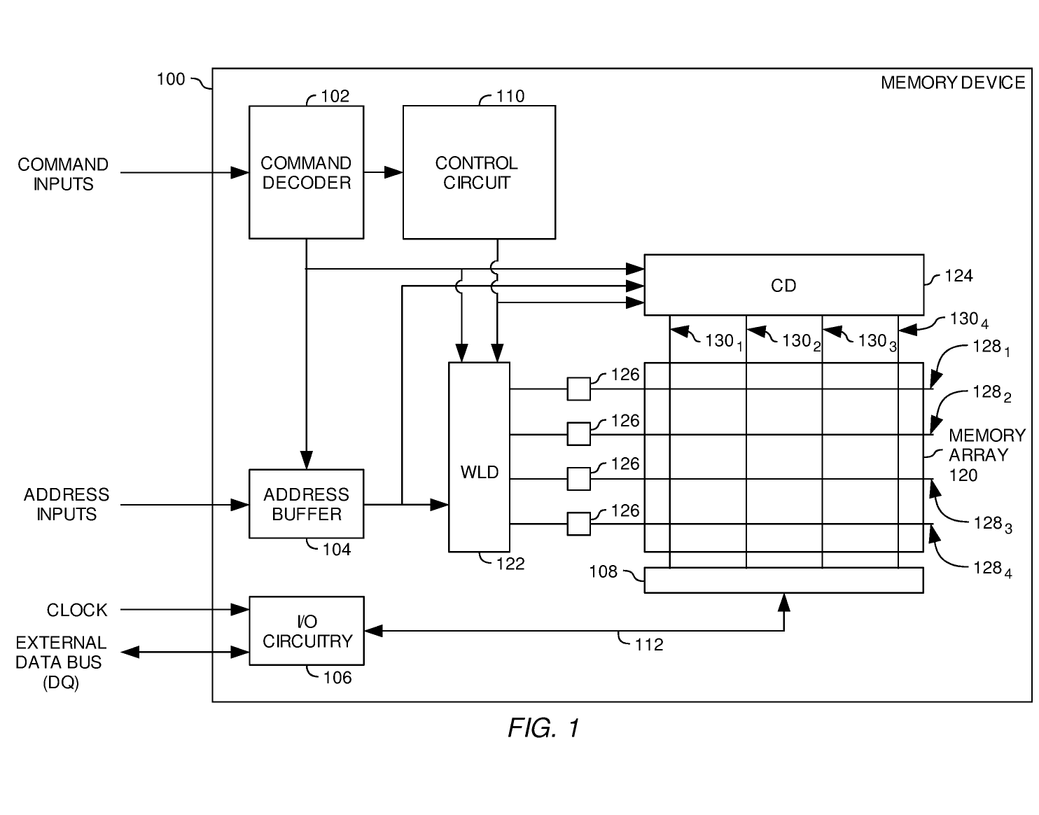

FIG. 1 is a block diagram depicting a memory device 100 according to one embodiment of the invention. The memory device 100 may include address inputs, command inputs, a clock input, and an external data bus (DQ). The address inputs may be received by an address buffer 104 and the command inputs may be received by a command decoder 102. The clock input and external data bus may be received by input/output (I/O) circuitry 106 and used to input and output data corresponding to access commands and addresses received via the command and address inputs. In some cases, the clock input may also be used to control the address buffer 104 and/or command decoder 102.

In one embodiment, the memory array 120 may have a given width, which may refer to the number of bitlines in the memory array 120 which are used to read from or write the memory array 120. Thus, the width of the memory array 120 may include redundant bitlines which are used to replace faulty bitlines in the memory array 120 but may not include redundant bitlines which are not used or faulty bitlines which have been replaced.

During an access, the address inputs may be used by a wordline decoder 122 and column decoder 124 to access memory cells in a memory array 120. For example, using a received address, the column decoder 124 may select bitlines 130 of the memory array 120 to be accessed. Similarly, the wordline decoder 126 may select wordlines 128 to be accessed using the received address. In some cases, an access may also occur based on an address which is internally generated.

After an address has been used to select wordlines and bitlines in the memory array 120, data may be written to and/or read from the memory array 120 via internal read/write circuitry 108 which may include circuitry such as sense amps, output buffers, etc. Data for the access may be transmitted between the read/write circuitry 108 for the memory array 120 and the external I/O circuitry 106 via one or more internal data buses 112. While depicted with respect to a single memory array 120, the memory device 100 may also include additional memory arrays as known to those skilled in the art. Furthermore, the combination of features and elements described above with respect to FIG. 1 is merely one example of a memory device configuration with which embodiments of the invention may be used. In general, embodiments of the invention may be utilized with any type of memory device 100.

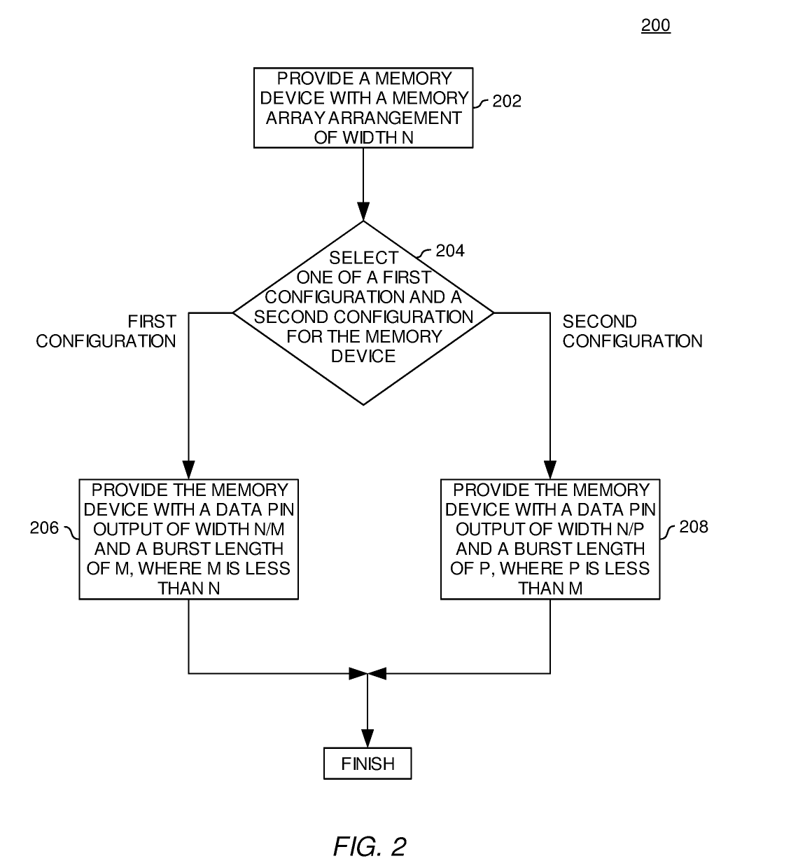

FIG. 2 is a flow diagram depicting a process 200 for providing configurations of a memory device according to one embodiment of the invention. The process may be performed, for example, by a manufacturer of the memory device which is providing the memory device to one or more customers. As depicted, the process 200 may begin at step 202 where a memory device with a memory array arrangement of a given width N is provided. At step 204, a selection between a first configuration of the memory device and a second configuration of the memory device may be made. For example, a first customer may request a first configuration of the device while a second customer may request a second configuration of the device. The manufacturer may provide both configurations using the same memory array arrangement. Also, embodiments of the invention may be utilized with three or more configurations which use the same memory array arrangement.

If the first configuration is selected, then at step 206, the memory device may be provided with a data pin output of width N/M and a burst length of M, where M is less than N. M and N may both be integers. The data pin output typically refers to the number of data pins in the data bus (also called DQ) used to transfer data to and from the memory device. The burst length typically refers to the number of consecutive read operations or write operations that may be performed with a burst read command or a burst write command. For example, in a double data rate (DDR) type memory, each read or write operation may occur on consecutive rising and falling edges of a clock signal (referred to as the data strobe signal, DQS) provided to the memory device. During each of the read operations or write operations, a number of bits equal to the data pin output number may be transferred to or from the memory device. Thus, with respect to step 206, N/M bits would be transferred each clock cycle by a memory device having the first configuration.

If the second configuration is selected, then at step 208, the memory device may be provided with a data pin output of width N/P and a burst length of P, where P is less than M. P may also be an integer, with N being divisible by both M and P as understood by those skilled in the art. Thus, the first configuration and the second configuration may utilize the same memory array arrangement of width N while providing different data pin counts N/M and N/P respectively.

In some cases, memory devices with either configuration may have the same number of data pin connections, but may only actively output data on N/M or N/P of the connections, respectively. Thus, in some cases, identical pin connections may be provided for each configuration of the memory device, while each data pin may not be used to input or output data from the memory device 100. Furthermore, in one embodiment, different configurations of the memory device may be provided in different packages such that the package for a corresponding configuration of the memory device only provides package data pin connections for the active data pins of the packaged memory device 100.

Also, in one embodiment, while the pin count and/or number of pins used to transmit data may be reduced for the first configuration, the first configuration may also provide a larger burst length M which is greater than P. Accordingly, both the first configuration and second configuration may utilize the full size of the internal memory array to perform burst read and write operations, even though one configuration has a smaller data pin count than the other configuration. Exemplary configurations are described below in greater detail.

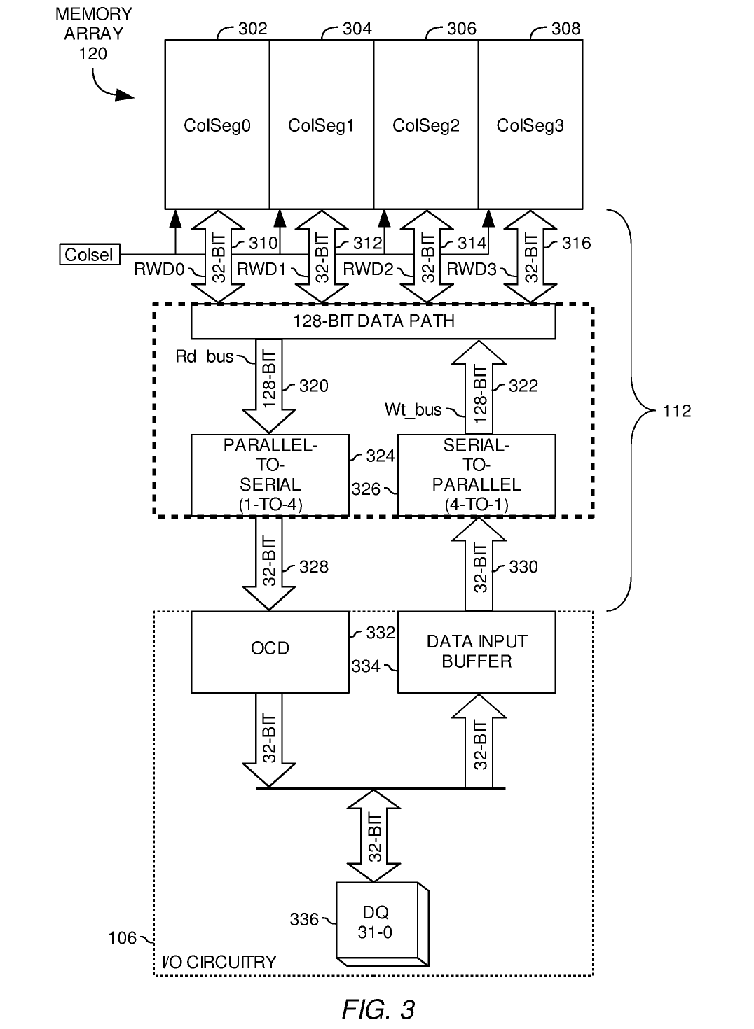

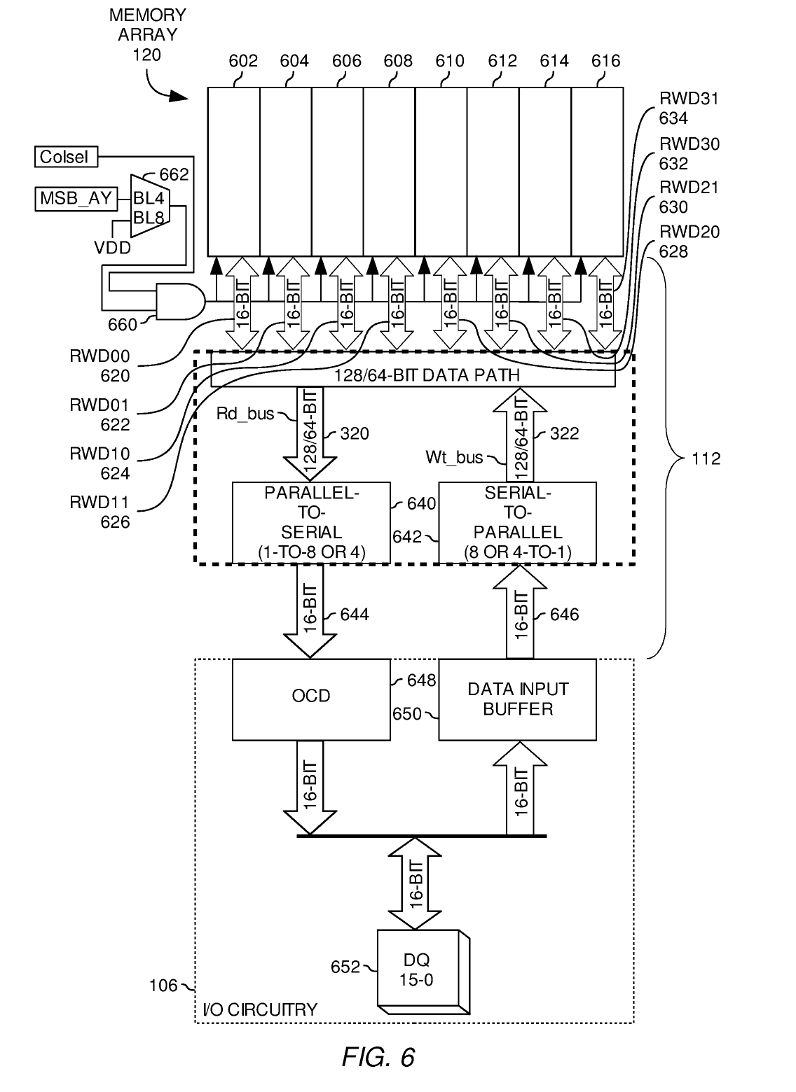

FIGS. 3 and 6, described below, depict exemplary configurations of a memory device 100. The embodiments depicted and described below provide conceptual descriptions of the operation of the memory device 100 in each of the separate configurations. However, it is noted that the memory device 100 may functionally have the capability to operate in either depicted configuration. Thus, differences between the depicted embodiments may be functional and do not necessarily reflect different underlying circuitry, as described below in greater detail.

FIG. 3 is a block diagram depicting one configuration of a memory device 100 according to one embodiment of the invention. The configuration depicted in FIG. 3 may correspond, for example, to a 128-bit data topology (e.g., with a data path which is 128 bits wide) in a 32 bit configuration (e.g., such that the external data bus provides 32 bits of data per access). As depicted, the configuration of FIG. 3 may include a memory array 120 with four column segments 302, 304, 306, 308. During an access to the memory array, the column select signal COLSEL may be used to activate the column segments 302, 304, 306, 308 and deliver data to or from the memory array 120.

During a read access, data may be transmitted from the memory array 120 to parallel to serial conversion circuitry 324 via a 128 bit read bus (RD_BUS) 320. From the parallel to serial conversion circuitry 324, the read data may be transmitted serially to an off-chip driver (OCD) 332 via a 32 bit data bus. The off-chip driver 332 may then transmit the serial data to the 32 bit external data bus (DQ<31:0>) 336.

During a write access, data may be transmitted from the 32 bit external bus 336 to a data input buffer 334. From the data input buffer 334, the data may be provided via a 32 bit internal but 330 to serial to parallel conversion circuitry 326. Where four cycles of 32 bits are written to the memory device 100, the serial to parallel conversion circuitry 326 may accumulate the serially written data and write the accumulated data to the memory array 120 via a 128 bit write bus (WT_BUS) 322.

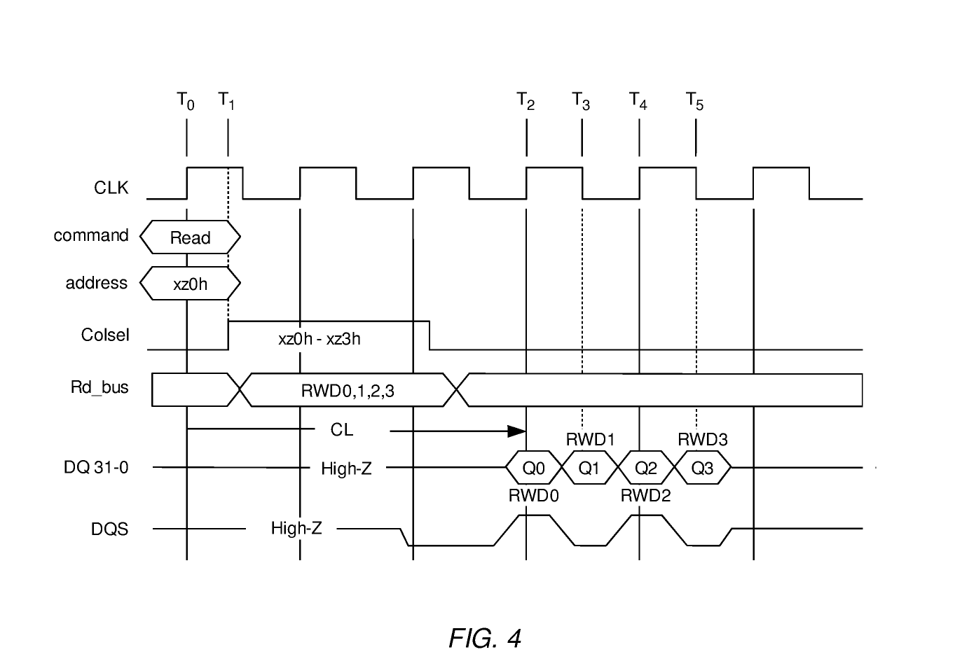

FIG. 4 is a timing diagram depicting a read operation with a burst length of four performed on the memory device 100 of FIG. 3 according to one embodiment of the invention. As depicted, the read operation may begin at time T0 where a read command and address are issued to the memory device 100. The memory device 100 may use the read address to read data from the memory array 120. For example, beginning at time T1, the memory device 100 may assert column select signals beginning at the read address which cause 128 bits of data to be read from the memory array 120 onto the RD_BUS 320.

In one embodiment, the lower order column address bits AY<1:0> of the column address may determine which addresses to read initially within a four address group, with each address corresponding to a different column segment 302 . . . 308. Thus, the lower order column address bits may not be decoded for a burst length of four, but may instead be used by the parallel to serial conversion circuitry 324 to determine the order with which read data is output. For example, where AY<1:0> is ‘00’, data from COLSEG0 302 may be read first followed by data from COLSEG1 304, COLSEG2 306, and COLSEG3 308. Where AY<1:0> is ‘10’, data from COLSEG2 306 may be read first followed by COLSEG3 306, COLSEG0 302, and COLSEG1 304 (thus wrapping around on the 4 address boundary).

As described above, after being converted from parallel data to serial data via the parallel to serial conversion circuitry 324, the read data may be output on the external data bus DQ<31:0> 336 beginning at time T2 (usually after a time greater than the CAS latency CL). Data from each column segment 302, 304, 306, 308 may be output, for example, beginning on the rising edge of the clock signal CLK at time T2 and continuing on each subsequent falling and rising edge at times T3, T4, and T5. Thus, over four clock cycles, 128 bits of data may be read from the memory device 100.

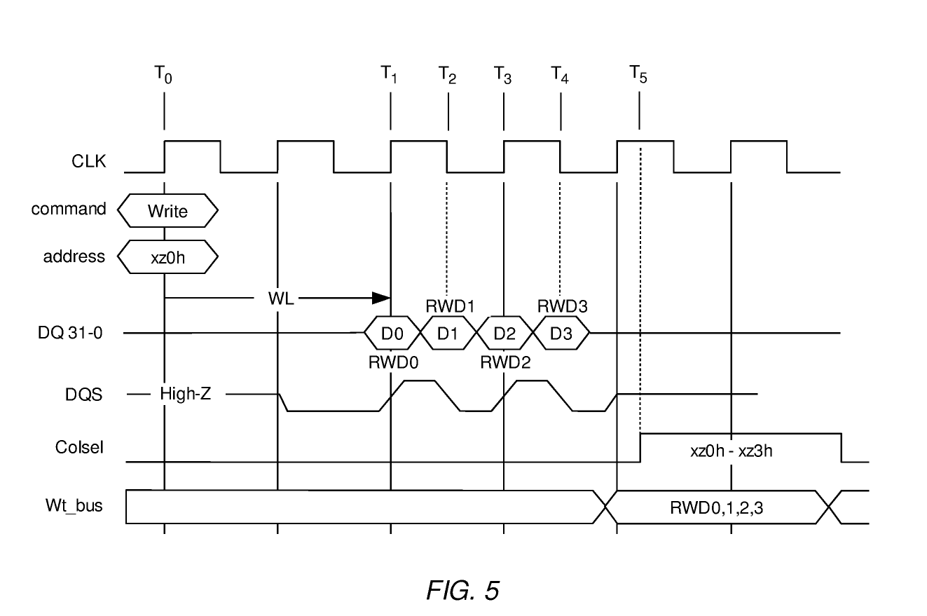

FIG. 5 is a timing diagram depicting a write operation with a burst length of four performed on the memory device configuration of FIG. 3 according to one embodiment of the invention. The write operation may begin at time T0 where a write command and write address are received. After the write latency WL and at time T1, the data may be received via the data bus DQ<31:0> 336 beginning at time T1. As depicted, 32 bits of data may be received on each rising and falling edge of the clock signal CLK at times T1, T2, T3, and T4. The serial to parallel conversion circuitry 326 may then accumulate the serially received data and input the data in parallel to the memory array 120 via the WT_BUS 322 at time T5. As with the read command, the column address bits AY<1:0> may indicate where the data being written should be written in the memory array 120. For example, where AY<1:0> is ‘00’, the first received data may be written to COLSEG0 302 and the following received data may be written to COLSEG1 304, COLSEG2 306, and COLSEG3 308, respectively, with all of the received data being written to the memory array 120 in parallel by the serial to parallel conversion circuitry 326. Where AY<1:0> is ‘10’, the first received data may be written to COLSEG2 306 with the following received data may be written to COLSEG3 306, COLSEG0 302, and COLSEG1 304, respectively (thus wrapping around on the 4 address boundary, as described above).

While described above with respect to read operations and write operations with a burst length of four, the configuration depicted in FIG. 3 may also be utilized with smaller burst lengths (e.g., a burst length of two) or for single accesses to a given memory address.

According to one embodiment of the invention, the 128 bit topology described above with respect to FIGS. 3-5 may also be used to provide alternative configurations of the memory device 100. For example, FIG. 6 is a block diagram depicting another configuration of the memory device 100 using the same 128 bit topology according to one embodiment of the invention. As depicted, in the configuration of FIG. 6, the same memory array 120 may be accessed via eight column segments (COLSEG00-COLSEG31) 602 . . . 616, each of which may provide access to 16 bits of data and may be accessible via eight 16-bit data lines (RWD00-RWD31) 620 . . . 634.

In one embodiment of the invention, the memory device 100 depicted in FIG. 6 may be configured to perform a read operation with a burst length of eight, such that 16 bits of data are read out over eight rising and falling clock edges. During a read access, data from the column segments 602 . . . 616 may be read via the data lines 620 . . . 634 and the 128 bit read bus (RD_BUS) 320 into the parallel to serial conversion circuitry 640. The parallel to serial conversion circuitry 640 may then output the data from each column segment 602 . . . 616 serially via a 16 bit bus 644 to the off chip driver 648. The off chip driver 648 may then output the serial data via the 16 bit external bus DQ<15:0>.

The memory device configuration depicted in FIG. 6 may also be configured to perform a write operation with a burst length of eight. During a write access, data may be received serially from the external data bus DQ<15:0> and transmitted via input buffer 650 and a 16 bit internal data bus 646 to serial to parallel conversion circuitry 642. The serial to parallel conversion circuitry 642 may accumulate the serially received data and then write the received data in parallel (e.g., 128 bits) via the WT_BUS 322 and data lines 620 . . . 634 to an address in the memory array 120.

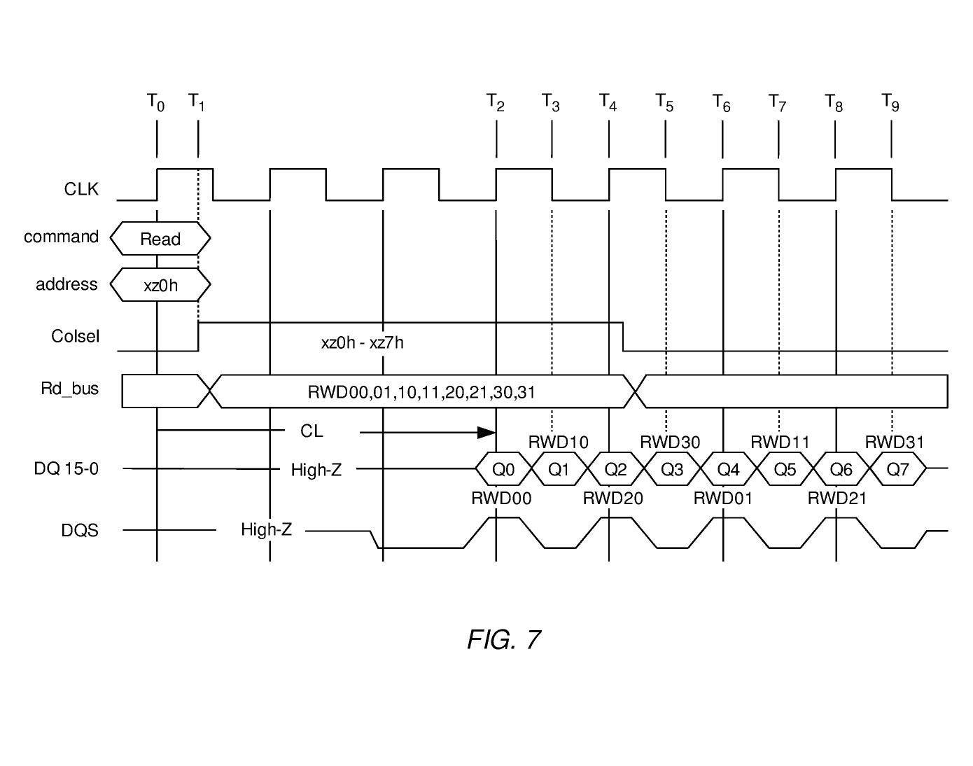

FIG. 7 is a timing diagram depicting a read operation with a burst length of eight performed on the memory device configuration of FIG. 6 according to one embodiment of the invention. As depicted, the read operation may begin at time T0 where a read command and address are issued to the memory device 100. At time T1, the read command and address may be used to perform a prefetch from the memory array 120. The prefetch may last for four clock cycles and retrieve 128 bits of data by asserting the column select signal for each of the column segments 602 . . . 616 in the memory array 120. The prefetched data may then be transmitted via the RD_BUS 320 to the parallel to serial conversion circuitry 640 as described above.

After the read data has been received by the parallel to serial conversion circuitry 640, the parallel to serial conversion circuitry 640 may output the received data serially (e.g., 16 bits at a time over eight rising and falling clock edges) via the off-chip driver 648 and external data bus DQ 652 beginning at time T2 and continuing until time T9. Where a burst length of eight is used, the lower order column address bits AY<2:0> may not be decoded but may instead determine the column segment 620 . . . 634 from which data should be initially output, wrapping around at an eight address boundary. For example, as depicted in FIG. 7, the read address may end in Oh (e.g., AY<2:0>=‘000’) such that data is output serially beginning with data read from COLSEG00 602 followed by data read from COLSEG01 604 . . . COLSEG31 616, respectively. If the low order column address bits were instead AY<2:0>=‘110’, the data would be output serially beginning with data from COLSEG30 614, followed by data from COLSEG31 616, (then, wrapping around) COLSEG 602 . . . COLSEG21 612, respectively.

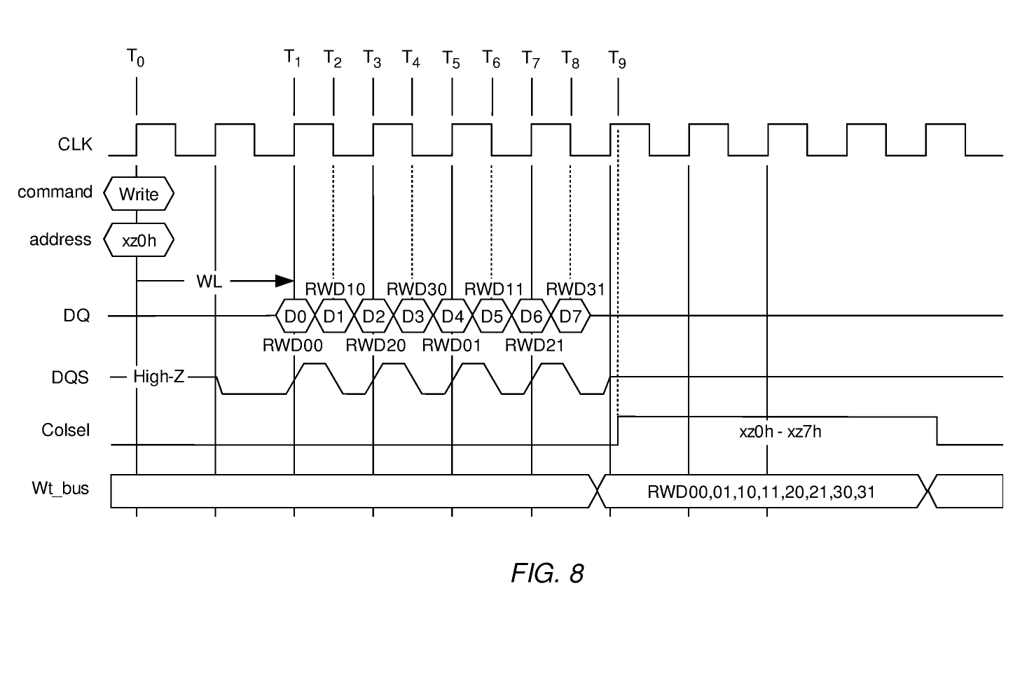

FIG. 8 is a timing diagram depicting a write operation with a burst length of eight performed on the memory device configuration of FIG. 6 according to one embodiment of the invention. As depicted, the write operation may begin at time T0 where a write command and write address are received. At times T1 through T9, write data for the write command may be received on each rising and falling edge of the clock signal CLK via the external data bus DQ 652.

During the write operation, the serially received write data may be accumulated by the serial to parallel conversion circuitry 642. After the write data has been accumulated, the serial to parallel conversion circuitry 642 may output the write data to the memory array 120 via the WT_BUS 322 beginning at time T9. As described above, the column address bits AY<2:0> may be used to determine which column segment 620 . . . 634 the first received write data should be written to, while wrapping around at the eight-address boundary as described above.

In some cases, the configuration depicted in FIG. 6 may provide improved access timing options. For example, for a write operation with a burst length of eight, the write may be divided internally into two consecutive writes to the memory array 120 of 64 bits each. For example, after accumulating 64 bits from four individual write accesses of 16 bits each, the serial to parallel conversion circuitry 642 may initiate a write of the data in parallel to the memory array 120 while asserting the column select signals to appropriate column segments 620 . . . 634 in the memory array 120. While the initially received 64 bits of data is being written in parallel to the memory array 120, subsequently received data (e.g., four write accesses, sixteen bits each, for 64 bits total) may be accumulated by the serial to parallel conversion circuitry 642. After the remaining four write accesses have been performed, the accumulated 64 bits may be written in parallel to the memory array 120 in a subsequent write while asserting the column select signals to appropriate column segments 620 . . . 634 in the memory array 120.

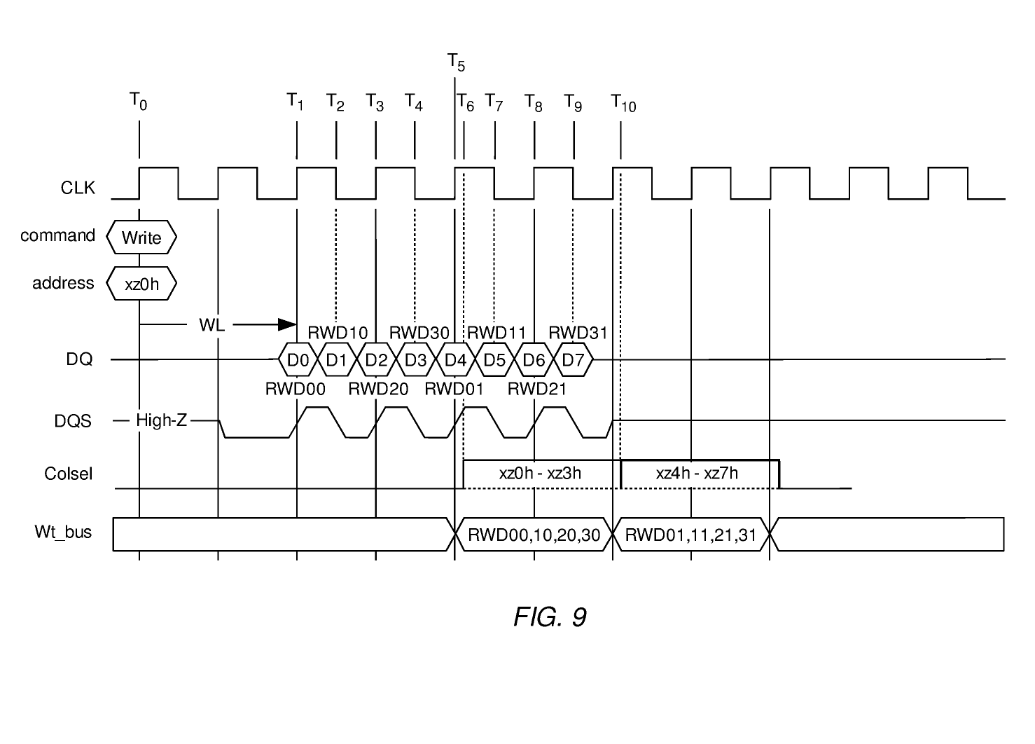

FIG. 9 is a timing diagram depicting a write operation performed on the memory device configuration of FIG. 6 with an alternate timing as described above according to one embodiment of the invention. As depicted, the write operation may begin at time T0 where a write command and write address are provided to the memory device 100. At time T1, and subsequent rising and falling edges of the clock signal CLK, write data for the write command may be received via the external data bus DQ. After four write accesses at times T1 . . . T4, the received write data may be written in parallel to the memory array 120 at time T6 using the WT_BUS 322 and column select signals as described above.

While the first half of the received data is being written to the memory array 120, the second half of the data may be received at times T5, T7, T8, and T9 and accumulated by the serial to parallel conversion circuitry 642. After the second half of the data has been received, the 64 bits of data may be written to the memory array 120 in parallel beginning at time T10 and using the WT_BUS 322 and column select signals as described above. Thus, in some cases, as depicted in FIG. 9, by starting the internal write access (time T6) from the serial to parallel conversion circuitry 642 to the memory array 120 while write data is still being received (times T5, T7, T8, T9), the burst write operation may be completed quickly.

While described above with respect to read and write operations performed with a burst length of eight, in one embodiment, the configuration depicted in FIG. 6 may also be utilized with smaller burst lengths (e.g., a burst length of two or four) or for single accesses to a given memory address. In such cases, the parallel to serial and serial to parallel circuitry 640, 642 may also be configured to operate with variable burst length settings.

For example, where an operation with a burst length of eight is performed, the decoding circuitry 660, 662 of the configuration depicted in FIG. 6 may not decode AY<2:0> into a column selection as described above (instead, AY<2:0> may be used to select the column segment 602 . . . 616 which is accessed during the burst read). During an operation with a burst length of four, the decoding circuitry 660, 662 may be configured to use the most significant bit of the column address (MSB_AY) to select a 64 bit portion of the memory array 120 where the operation (e.g., read or write) should be performed. For example, if MSB_AY is “0”, the data for the operation may be accessed in a first half of the memory array 120, while if MSB_AY is “1”, the data for the operation may be accessed in a second half of the memory array 120.

In one embodiment of the invention, for the 16 bit configuration depicted in FIG. 6, the external bus frequency of the memory device 100 may be doubled with respect to the 32 bit configuration of FIG. 3 such that the memory device configuration of FIG. 6 provides equivalent bandwidth to the memory device configuration of FIG. 3. For example, if the memory device configuration of FIG. 3 operates with an external bus frequency 400 megahertz (MHz), then the memory device configuration of FIG. 6 may be operated with an external bus frequency of 800 MHz while each configuration may maintain an equivalent internal memory array access time.

As described above, FIGS. 3 and 6 depict separate configurations of a single memory device 100 with identical internal data path topology (e.g., a 128 bit data path) and memory array arrangements. In general, differences between each of the configurations may be implemented in any manner. For example, a single memory device 100 may be manufactured with the full capabilities of both configurations, and during operation of the device, a given configuration may be selected. Selection of the configuration during operation may be performed, for example, by setting control register bits indicating which configuration should be utilized as well as the burst length which should be utilized. Optionally, in one embodiment, the burst length may be specified when a command is issued to the memory device 100. Also, in one embodiment, fuses may be used to select between configurations. For example, one or more fuses may be blown to select a configuration of the memory device. The fuses may be any type of fuse including a laser-cut fuse or an electronically programmable fuse (an e-fuse).

Where device configurations are changed dynamically during operation and/or via fuses, circuitry used in the data path (e.g., parallel to serial conversion circuitry 324, 640, serial to parallel conversion circuitry 326, 642, off chip driver 332, 648, etc., and column selection circuitry) may be provided with multiple modes of operation in order to accommodate both possible configurations of the memory device 100. Optionally, in some cases, the multiple configurations of the memory device 100 may be provided during manufacturing by providing different components and/or connections for each of the device configurations.

In one embodiment of the invention, selection of a memory device configuration may be performed during packaging of the memory device 100. For example, as described above, where the configurations of the memory device 100 use different numbers of data pins to transfer data to and from the memory device 100, then during packaging, the memory device 100 may be packaged such that the package only provides external package data pins for the active data pins of the memory device configuration. Thus, in the configuration described above with respect to FIG. 3, the memory device 100 may include 32 data pin connections, each of which may provided as an external pin connection on the package for the memory device 100. With respect to the configuration of FIG. 6, the memory device 100 may also include 32 data pin connections, but only 16 of the data pin connections may be used to transmit data to and from the memory device 100. Thus, the package for the memory device 100 of FIG. 6 may only provide external data pin connections to the 16 active pins of the memory device 100.

Furthermore, in one embodiment, and external configuration pin may be provided on the memory device 100 and the external configuration pin may be used to place the memory device 100 in one of the first and the second configuration. For example, if a first voltage is applied to the external configuration pin, the memory device 100 may be placed in a first configuration, while if a second voltage is applied to the external configuration pin, the memory device 100 may be placed in the second configuration. In one embodiment, the configuration pin connection may be fixed during packaging to a given voltage in order to select the configuration. Optionally, the configuration pin may be routed to an external pin of the package, allowing the configuration to be selected after the package is connected to another device by a user of the package.

While described above with respect to configurations with external data bus widths of 32 bits and 16 bits, configurations of the memory device may also be provided with other external data bus widths (e.g., eight bits or 64 bits) while scaling the burst lengths of the configured device and using the full capability of the internal data bus and memory array accordingly. For example, in an eight bit configuration, the maximum burst length may be 16, while lower burst lengths may also be provided. For example, in the eight bit configuration, to perform a write operation with a burst length of eight, the same operation depicted with respect to FIG. 9 may be performed while truncating (e.g., omitting) the last four cycles in which additional data is written to the memory array 120 (e.g., the write beginning at time T10 may be omitted because 64 bits of data have already been written beginning at time T6).

While the foregoing is directed to embodiments of the present invention, other and further embodiments of the invention may be devised without departing from the basic scope thereof, and the scope thereof is determined by the claims that follow.

What is claimed is:

1. A method of providing memory device, comprising:
providing a memory device with a memory array arrangement of width N;
providing a first configuration of the memory device and a second configuration of the memory device, wherein:
providing the first configuration of the memory device comprises providing the memory device with a burst length of M, wherein N/M data pins are used to communicate data with the memory device and wherein M is less than N; and
providing the second configuration of the memory device comprises providing the memory device with a burst length of P, wherein N/P data pins are used to communicate data with the memory device, wherein P is less than M, and wherein M, N, and P are all integers.

2. The method of claim 1, further comprising:
selecting one of the first configuration and the second configuration of the device to use during operation of the memory device, wherein selecting comprises at least one of:
writing a selection value to a register of the memory device; and
blowing one or more fuses of the memory device to indicate which one of the first configuration and the second configuration is selected.

3. The method of claim 1, wherein N is 128, M is 8, and P is 4.

4. The method of claim 1, wherein the data pin output of width N/P is twice the data pin output of width N/M.

5. The method of claim 4, wherein an external bus frequency for the first configuration is twice the external bus frequency for the second configuration.

6. The method of claim 1, wherein the first configuration includes a mode which provides a burst length of P.

7. The method of claim 1, wherein the memory device is configured to perform a burst write operation in the first configuration comprising:
receiving a first P data items;
writing the first P data items in parallel to the memory array;
receiving a second P data items; and
writing the second P data items in parallel to the memory array after the first P data items have been written to the memory array.

8. The method of claim 1, wherein, during a burst access operation, the memory device is configured to use one or more least significant bits of a column address for the access operation to determine respective column segments of the memory array where data for the access operation is to be accessed, wherein the data is accessed from all of the respective column segments of the memory array in parallel during the access operation.

9. A method of operating a memory device, comprising:
configuring the memory device having a memory array arrangement of width N, into a first configuration having a burst length of M, wherein N/M data pins are used to communicate data with the memory device and wherein M is less than N;
configuring the memory device having the memory array arrangement of width N into a second configuration having a burst length of P, wherein N/P data pins are used to communicate data with the memory device, wherein P is less than M, and wherein M, N, and P are all integers; and
operating the memory device using one of the first configuration and the second configuration.

10. The method of claim 9, further comprising:
selecting one of the first configuration and the second configuration of the device to use during operation of the memory device, wherein selecting comprises at least one of:
writing a selection value to a register of the memory device; and
blowing one or more fuses of the memory device to indicate which one of the first configuration and the second configuration is selected.

11. The method of claim 9, wherein N is 128, M is 8, and P is 4.

12. The method of claim 9, wherein the data pin output of width N/P is twice the data pin output of width N/M.

13. The method of claim 12, wherein an external bus frequency for the first configuration is twice the external bus frequency for the second configuration.

14. The method of claim 9, wherein the first configuration includes a mode which provides a burst length of P.

15. The method of claim 9, wherein the memory device is configured to perform a burst write operation in the first configuration comprising:
receiving a first P data items;
writing the first P data items in parallel to the memory array;
receiving a second P data items; and
writing the second P data items in parallel to the memory array after the first P data items have been written to the memory array.

16. The method of claim 9, wherein, during a burst access operation, the memory device is configured to use one or more least significant bits of a column address for the access operation to determine respective column segments of the memory array where data for the access operation is to be accessed, wherein the data is accessed from all of the respective column segments of the memory array in parallel during the access operation.

17. A memory device comprising:
a memory array of width N;
a selected configuration comprising at least one of:
a first configuration of the memory device configured to provide a burst length of M wherein N/M data pins are used to transmit data to the memory device and wherein M is less than N; and
a second configuration of the memory device configured to provide a burst length of P wherein N/P data pins are used to transmit data to the memory device, wherein P is less than M, and wherein M, N, and P are all integers.

18. The memory device of claim 17, further comprising:
selection circuitry configured to select one of the first configuration and the second configuration of the device to use during operation of the memory device: wherein selecting comprises at least one of:
detecting a selection value in a register of the memory device; and
determining whether one or more fuses of the memory device have been blown to indicate one of the first configuration and the second configuration is selected.

19. The memory device of claim 17, wherein N is 128, M is 8, and P is 4.

20. The memory device of claim 17, wherein the data pin output of width N/P is twice the data pin output of width N/M.

21. The memory device of claim 20, wherein an external bus frequency for the first configuration is twice the external bus frequency for the second configuration.

22. The memory device of claim 17, wherein the first configuration includes a mode which provides a burst length of P.

23. The memory device of claim 17, wherein the memory device further comprises circuitry configured to:
perform a burst write operation in the first configuration comprising:
receiving a first P data items;
writing the first P data items in parallel to the memory array;
receiving a second P data items; and
writing the second P data items in parallel to the memory array after the first P data items have been written to the memory array.

24. The memory device of claim 17, wherein the memory device further comprises circuitry configured to:
use one or more least significant bits of a column address for an access operation to determine respective column segments of the memory array where data for the access operation is to be accessed; and
access the data from all of the respective column segments of the memory array in parallel during the access operation.

25. A method of operating a memory device, comprising:
selectively operating the memory device with a memory array of width N using one of at least a first configuration and a second configuration,
wherein, when the first configuration is selected, the memory device is configured to transmit data using N/M data pins and a burst length of M, where M is less than N; and
wherein, when the second configuration is selected, the memory device is configured to transmit data using N/P data pins and a burst length of P, where P is less than M, wherein M, N, and P are all integers.

26. The method of claim 25, wherein N is 128, M is 8, and P is 4.

27. The method of claim 25, wherein the data pin output of width N/P is twice the data pin output of width N/M.

28. The method of claim 27, wherein an external bus frequency for the first configuration is twice the external bus frequency for the second configuration.

29. The method of claim 25, wherein the memory device is configured to perform a burst write operation in the first configuration comprising:
receiving a first P data items;
writing the first P data items in parallel to the memory array;
receiving a second P data items; and
writing the second P data items in parallel to the memory array after the first P data items have been written to the memory array.

30. The method of claim 25, wherein, during a burst access operation, the memory device is configured to use one or more least significant bits of a column address for the access operation to determine respective column segments of the memory array where data for the access operation is to be accessed, wherein the data is accessed from all of the respective column segments of the memory array in parallel during the access operation.

31. A memory device comprising:
a memory array of width N;
circuitry configured to select a configuration of the memory device from at least a first configuration and a second configuration,
wherein, when the first configuration is selected, the memory device is configured to transmit data using N/M data pins and a burst length of M, where M is less than N; and
wherein, when the second configuration is selected, the memory device is configured to transmit data using N/P data pins and a burst length of P, where P is less than M, wherein M, N, and P are all integers.

32. The memory device of claim 31, wherein N is 128, M is 8, and P is 4.

33. The memory device of claim 31, wherein an external bus frequency for the first configuration is twice the external bus frequency for the second configuration.

34. The memory device of claim 33, wherein the first configuration includes a mode which provides a burst length of P.

35. The memory device of claim 31, wherein the memory device further comprises circuitry configured to:
perform a burst write operation in the first configuration comprising:
receiving a first P data items;
writing the first P data items in parallel to the memory array;
receiving a second P data items; and
writing the second P data items in parallel to the memory array after the first P data items have been written to the memory array.

36. The memory device of claim 31, wherein the memory device further comprises circuitry configured to:
use one or more least significant bits of a column address for an access operation to determine respective column segments of the memory array where data for the access operation is to be accessed; and
access the data from all of the respective column segments of the memory array in parallel during the access operation.

37. A memory device comprising:
a memory array of width N;
a selected configuration comprising at least one of:
a first configuration of the memory device configured to provide a burst length of M wherein the memory device provides N/M external data pins which are used to transmit data to the memory device and wherein M is less than N; and
a second configuration of the memory device configured to provide a burst length of P wherein the memory device provides N/P external data pins which are used to transmit data to the memory device, wherein P is less than M, and wherein M, N, and P are all integers.
